(19) United States
(12) Patent Application Publication
(10) Pub. No.: US 2006/0132459 A1
(43) Pub. Date: Jun. 22, 2006

(54) Interpreting an image

(76) Inventors: Wyatt A. Huddleston, Allen, TX (US); Michael M. Blythe, Albany, OR (US); Jonathan J. Sandoval, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/018,187

(22) Filed: Dec. 20, 2004

(51) Int. Cl. G09G 5/00

(52) U.S. Cl. 345/173

(57) ABSTRACT

A method in accordance with one embodiment of the present disclosure includes capturing an image corresponding to an object tapping on a display surface and interpreting the image as a computer command.

### BACKGROUND

Display systems can be configured to have interactive capability. Interactive capability may allow a display system to receive input commands and/or input data from a user of the display system. However, there may be certain drawbacks associated with the use of some input devices in conjunction with a display system.

### DESCRIPTION OF THE DRAWINGS

FIG. 1 depicts a schematic representation of an embodiment of an apparatus in accordance with one embodiment of the present disclosure.

FIG. 2 depicts a flow diagram in accordance with one embodiment of a method of the present disclosure.

FIG. 3 depicts a front view of an embodiment of a display panel, wherein an example of recognizable features or characteristics of one or more fingertips is shown in accordance with one embodiment of the present disclosure.

FIG. 4 depicts another front view of an embodiment of a display panel, wherein an example of recognizable features or characteristic of one or more fingertips is shown in accordance with one embodiment of the present disclosure.

FIG. 5 depicts another front view of an embodiment of a display panel, wherein an example of recognizable features or characteristics of one or more fingertips is shown in accordance with one embodiment of the present disclosure.

FIG. 6 depicts another front view of an embodiment of a display panel, wherein an example of recognizable features or characteristics of one or more fingertips is shown in accordance with one embodiment of the present disclosure.

FIG. 7 depicts another front view of an embodiment of a display panel, wherein an example of recognizable features or characteristics of one or more fingertips is shown in accordance with one embodiment of the present disclosure.

### DETAILED DESCRIPTION

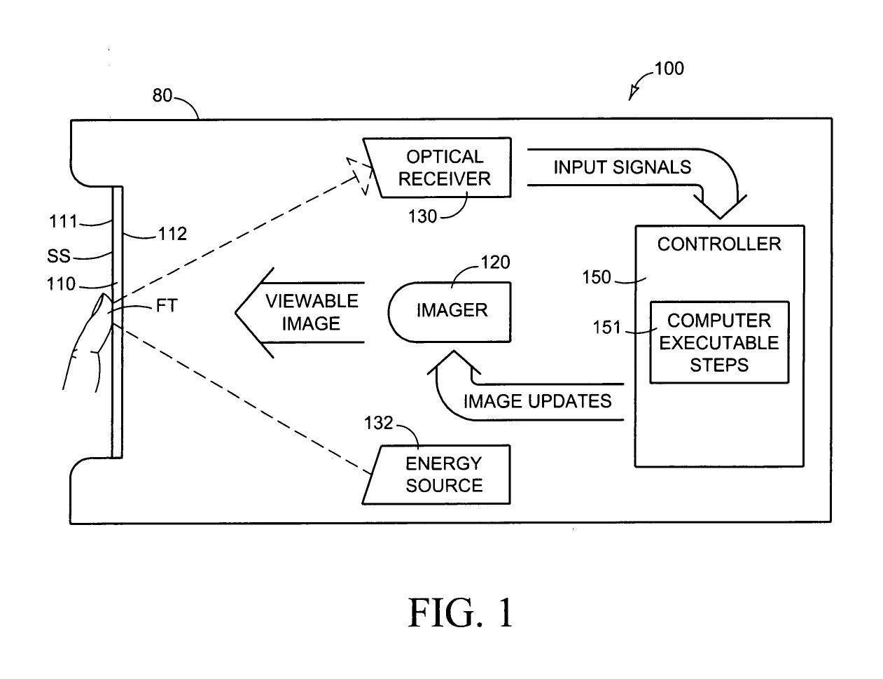

With reference to the drawings, FIG. 1 depicts a schematic representation of an apparatus or system 100 in accordance with at least one embodiment of the present disclosure. The schematic representation depicted in FIG. 1 can be a cross-sectional side elevation view or a cross-sectional plan view, depending upon the specific configuration of the apparatus 100. The apparatus 100 can be substantially in the form of a display system or the like. That is, the apparatus 100 can be generally configured to display images that are viewable by one or more users of the apparatus.

The apparatus 100 can include a display panel 110. The display panel 110 can be substantially flat as is depicted, although it may be otherwise. The display panel 110 can be substantially in the form of a plate. Although the display panel 110 is depicted as having a substantially vertical, or upright, orientation, it is understood that the display panel can have any suitable orientation. For example, although not shown, the display panel 110 can have a substantially horizontal orientation. That is, the apparatus 100 can be oriented in a manner, wherein the display panel 110 is a substantially horizontal “table top” display panel.

The display panel 110 can be substantially transparent. The display panel 110 can be fabricated from any of a number of suitable materials such as, but not limited to, glass, polycarbonate, and the like. The display panel 110 can also be fabricated from a composition of different materials. For example, the display panel 110 can be composed of a plurality of layers (not shown), wherein each layer can be fabricated from a substantially different material.

The display panel 110 can have a first side 111 and an opposite second side 112. The first side 111 and the second side 112 can be substantially parallel to one another, although they may be otherwise. A display surface “SS” can be defined on the display panel 110. The display surface SS can be defined on the first side 111 of the display panel 110. The display panel 110 can be supported on a chassis 80, or other similar support structure.

The display panel 110 is configured to display a viewable image that is viewable on the display surface SS, or from the first side 111. A viewable image can be displayed on the display surface SS of the display panel 110 by way of any of a number of suitable image-generating devices. For example, the apparatus 100 can include an imager 120 that is configured to generate a viewable image. The imager 120 can be further configured to project the viewable image on the display panel 110.

More specifically, the imager 120 can be configured to project a viewable image toward the second side 112 of the display panel 110, so that the viewable image can be viewed from the first side 111, and/or so that the viewable image can be viewed on the display surface SS. The imager 120 can have any of a number of suitable specific forms and/or configurations. For example, the imager 120 can be substantially in the form of a digital light projector (or “DLP”). The imager 120 can be supported on the chassis 80.

In an exemplary embodiment, the imager 120 includes, and/or can be substantially in the form of, one or more spatial light modulators (not shown). In general, a spatial light modulator includes an array of pixel elements (not show) that can be utilized in combination with a dedicated light source (not shown) to form an array of pixels on the panel 110 to define a viewable image.

Each pixel element can be controlled to adjust an intensity and/or “on time” of each image pixel to determine a perceived intensity of the pixel. Examples of spatial light modulators include, but are not limited to, devices such as “micromirrors”, “digital light processors”, and “liquid crystal displays” (or “LCD” panels). The imager 120 can include one or more color filters (not shown) configured to produce filtered light having given light frequency spectral characteristics.

In accordance with at least one embodiment of the present disclosure, the apparatus 100 can be further configured to allow a user of the apparatus to convey commands (such as input commands and/or computer commands) and/or data to the apparatus and/or to various components of the apparatus by placing one or more objects such as one or more of the user's fingertips “FT” proximate to, or into contact with, the display panel 110.

It should be recognized that in accordance with various embodiments of the present disclosure, various types of objects other than fingertips FT may be used. For example, in one embodiment of the present disclosure, a type of member such as another part of a finger, such as one or more knuckles or one or more thumbs, may be used. In other embodiments, other types of members such as one or more pointers or even a pen or pencil may be used.

Accordingly, it should be recognized that fingertips FT are depicted and described herein as an illustrative example in accordance with an exemplary embodiment of the present disclosure. That is, the specific illustrative use of the term “fingertips” and the specific illustrative depiction of fingertips FT herein is not intended to limit the type of objects contemplated to be used in accordance with various embodiments of the present disclosure. Therefore, it should be understood that where ever the term “fingertips” and/or “fingertip” is used herein, and where ever a fingertip FT is specifically depicted herein, the use of other specific types of objects other than fingertips is contemplated in accordance with various embodiments of the present disclosure.

More specifically, the apparatus 100 can be configured to allow a user of the apparatus to bring one or more objects, such as the user's fingertips FT, into proximity or contact with the first side 111 of the display panel 110 in one or more various manners in order to convey commands (such as input commands and/or computer commands) to one or more components of the apparatus 100.

For example, one or more fingertips FT can be positioned and/or moved in any of a number manners while proximate to, or in contact with, the display panel 110, wherein a given position and/or manner of movement of one or more fingertips indicates a corresponding associated computer command. The positions and/or manner of movement of the one or more fingertips FT for conveying computer commands or the like and/or data is discussed in greater detail below.

The apparatus 100 can be configured to recognize commands and/or data that is conveyed by one or more fingertips FT proximate to, or in contact with, the display panel 110 while a viewable image is displayed on the display surface SS, or first side 111. It is understood that the meaning of the terms “proximate to” or “in proximity with” as used herein when describing the positions of one or more fingertips FT in relation to the display panel 110, is intended to encompass fingertips that are “in contact with” the display panel, unless specifically described otherwise.

That is, fingertips FT (or other objects) that are described herein as proximate to, or in proximity with, the display panel 110, can be substantially close to and/or in contact with the display panel. Furthermore, although one or more of the accompanying figures, as well as certain illustrative examples given in the written description, may depict and/or describe the fingertips FT as being in contact with the display panel 110, it is understood that the fingertips may not be in contact with the display panel, but could be in proximity with the display panel.

The apparatus 100 can include an optical receiver 130. The optical receiver can be supported on the chassis 80. The optical receiver 130 can be configured to optically detect one or more fingertips FT in proximity with the first side 111 of the display panel 110. That is, for example, the optical receiver 130 can be configured to detect the presence of at least one fingertip FT in proximity with the first side 111 of the display panel 110 by receiving light that illuminates, or reflects from, the one or more fingertips.

In accordance with at least one embodiment of the present disclosure, the optical receiver 130 can be substantially in the form of a camera or the like that is configured to “take a picture” while it is aimed at the second side 112 of the display panel 110. Thus, inasmuch as the display panel 110 can be substantially transparent to light of at least a given spectral frequency range, the optical receiver 130 can detect one or more fingertips FT in proximity with the display panel by capturing an image of, or an image corresponding to, the one or more fingertips in the manner of a camera capturing an image.

As a more specific example, the optical receiver 130 can be substantially in the form of a digital camera that generates a “real time” digital signal and/or digital data indicative of what the optical receiver 130 “sees” when it is aimed at, or directed toward, the second side 112 of the display panel 110, as is depicted. When the optical receiver 130 is configured substantially in the manner of a camera, the optical receiver can be configured to take a series of still “snapshots” or can be configured to take a substantially continuous “video stream.”

As is briefly mentioned above, the one or more fingertips FT in proximity with the display panel 110 can be illuminated in order to facilitate detection of the fingertips by the optical receiver 130. Illumination of the fingertips FT can be accomplished by light that can originate from any of a number of suitable possible sources. For example, the light produced by the imager 120 can be used to illuminate the fingertips FT in proximity with the display panel 110.

That is, light which makes up a portion of the viewable image generated by the imager 120 can be employed to illuminate the fingertips FT in proximity with the display panel 110. However, the imager 120 can be configured to produce additional light that is intended to be used for illumination of the fingertips FT, wherein the additional light is not a portion of the viewable image. In other words, such additional light can be extraneous to the viewable image produced by the imager 120. Furthermore, ambient light such as sunlight or light from light sources external to the apparatus 100 can provide at least partial illumination of the fingertips FT and/or other objects to be recognized by the apparatus.

The light for illuminating the fingertips FT in proximity with the display panel 110 can be produced by an energy source 132 that is separate from the imager 120. The energy source 132 can be supported on the chassis 80. The energy source 132 can be in any suitable position that enables the energy source to direct light energy toward the second side 112 of the display panel 110 in a manner that facilitates detection of the one or more fingertips FT by the optical receiver 130. Light produced by the energy source 132 and utilized to illuminate the fingertips FT can be light that falls at least partially outside of the visible light spectrum.

The apparatus 100 can further include control electronics, or a controller, 150. The controller 150 can be configured to carry out various control and/or data processing functions in regard to the operation of the apparatus 100. The controller 150 can contain, and/or can be communicatively linked with, a set of computer executable steps or instructions 151. The computer executable steps 151 can be substantially in the form of, or contained on, computer readable media.

It is understood that the controller 150 can be separate from the remainder of the apparatus 100 as generally described herein. That is, the apparatus 100 can be generally configured as a unit without the controller 150, wherein the controller is incorporated in a separate apparatus or unit, such as a personal computer or the like, and which controller can be communicatively linked with the apparatus 100 to provide control functions as described herein.

The computer executable steps 151 can be configured to enable the controller 150 to carry out various functions including, but not limited to, functions which are specifically described herein. The computer executable instructions 151 can be configured to perform various functions such as causing the controller 150 to display an image on the display panel 110. Additionally, the controller 150 and/or the computer executable steps 151 can be configured to function in association with the optical receiver 130 to recognize various distinguishing features or characteristics of objects such as the fingertips FT in proximity with the display panel 130.

Such distinguishing features, or characteristics, of the fingertips FT can include, but are not limited to, the number of fingertips in proximity with the display panel 110, the number of fingertips that are moving, and/or the number of fingertips that are substantially stationary relative to the display panel, as well as the relative positions and/or patterns of the fingertips relative to one another and/or relative to the display panel.

The apparatus 100 can accomplish this task of recognizing such distinguishing features or characteristics of the fingertips FT by capturing an “image” of, or an image corresponding to, the fingertips that are in proximity with the display panel 110. The task of detecting, or capturing the “image” of, or corresponding to, the fingertips FT can be generally carried out by the optical receiver 130 in the manner described above.

The optical receiver 130 can then transmit input signals to the controller 150, wherein the input signals are indicative of the fingertips FT in proximity with the display panel 110. More specifically, for example, the input signals transmitted from the optical receiver 130 to the controller 150 can substantially contain, and/or be indicative of, or correspond to, images of the display panel 110, in which images the fingertips FT in proximity with the display panel are shown.

The controller 150, in conjunction with the computer executable steps 151, can process the input signals received from the optical receiver 130. Processing the input signals can include analyzing the input signals. Such analysis of the input signals can be performed by the controller 150 and/or the computer executable steps 151. The controller 150 and/or computer executable steps 151 can perform the analysis of the input signals in association with one or more various types of “object recognition” technology.

For example, the controller 150, and/or the computer executable steps 151, can be configured to analyze digital images of the display panel 110, which images are captured by the optical receiver 130 in the manner described above. The controller 150 and/or the computer executable steps 151 can be further configured to recognize specific features or characteristics of analyzed images including, but not limited to, specific shapes of objects and/or specific sizes of objects and/or specific reflectivity of objects and/or specific color of objects which are shown in the images.

In this manner, the controller 150, in conjunction with the optical receiver 130 and/or the computer executable steps 151, can be configured to recognize the presence of one or more fingertips FT in proximity with the first side of the display panel 110 by recognizing the shape and/or size and/or reflectivity or the like of one or more fingertips in proximity with the display panel. The controller 150, and/or the computer executable steps 151, can be further configured to perform additional analysis of the image, or images, captured by the optical receiver 130.

Such additional analysis can include determining more precisely how many fingertips FT are in proximity with the display panel 110, and/or how many fingertips are touching the display panel. This can be accomplished by configuring the controller 150 to count, and keep track of, the number of fingertips FT that it recognizes as being in proximity with and/or are touching the display panel 110. Similarly, the controller 150 can be configured to recognize which of the fingertips FT are moving relative to the display panel 110, and/or which of the fingertips are substantially stationary relative to the display panel.

Moreover, the controller 150 can be configured to recognize various patterns and/or positions of the fingertips FT relative to one another. For example, the controller 150 can be configured to recognize that three fingertips FT in proximity with the display panel 110 are arranged substantially in a straight line. Or, the controller 150 can be configured to recognize that three fingertips FT in proximity with the display panel 110 are arranged substantially in a triangle, for example.

As an added example, the controller 150 can be configured to recognize respective positions of fingertips FT relative to the display panel. That is, a fingertip FT can be recognized as being within a given area of the display panel 110, wherein the given area can be defined in terms of a number of possible parameters. For example, a given area of the display panel 110 can be defined in relation to the display panel itself, such as the “upper portion” of the display panel, or the “lower portion” of the display panel, or the “right portion” of the display panel, or the “left portion” of the display panel.

The given area of the display panel 110 can also be defined in relation to an image displayed on the display panel. For example, a given area of the display panel can be defined as falling within a given image or portion of a given image displayed on the display panel. An example of such a given image can include, but is not limited to, a control panel image or the like.

Other features or characteristics of the fingertips FT can be recognizable by the controller 150. For example, the direction of movement of a given fingertip FT relative to the display panel 110 can be recognizable. That is, the given fingertip FT can be recognized as moving toward, for example, the left side of the display panel 110 and/or the upper side of the display panel. Moreover, a path of movement of a given fingertip FT can be recognizable. For example, the given fingertip FT can be recognized as moving along a path having a given shape.

In accordance with at least one exemplary embodiment of the present disclosure, an imaging sequence can be captured by the optical receiver 130, wherein the imaging sequence captures movement of one or more fingertips FT relative to the display panel 110. The imaging sequence can then be stored so as to be accessible by the controller 150 and/or by the computer executable steps 151. For example, such an imaging sequence can be stored in a memory device or the like (not shown) that is accessible by the controller 150 and/or by the computer executable steps 151.

The controller 150 and/or the computer executable steps 151 can access and analyze the imaging sequence to determine differences between one image of the sequence and a subsequent image of the sequence. The controller 150 and/or the computer executable steps 151 can be configured to assign a given movement to the fingertips FT based on the differences between individual images of the image sequence. That is, the controller 150 can interpret given differences between two or more given images as a given movement of the fingertips FT. Furthermore, the controller 150 and/or computer executable steps 151 can be configured to perform a statistical analysis in accordance with one or more methods to predict the most likely match between one image of the imaging sequence and a subsequent image.

The differences between two or more images in an image sequence can be employed for one or more purposes. For example, image differences relative to the image capture rate can be interpreted as velocity of one or more fingertips FT relative to the display panel 110. A velocity of a fingertip FT that is determined in such a manner can be employed to predict a position of a given fingertip in a subsequent image.

The term “processing” can include “interpreting” various features or characteristics of one or more fingertips FT in proximity with the display panel 110 as associated commands and/or input data. That is, the controller 150 and/or the computer executable instructions 151 can be configured to interpret a given recognized distinguishable feature or characteristic of one or more fingertips FT in proximity with the display panel 110 as an associated computer command, or at least a portion of an associated computer command, and/or as corresponding input data.

The interpretation of a given feature or characteristic of the fingertips FT in proximity with the display panel as a computer command, or portion thereof or the like, can be accomplished by configuring the controller 150 and/or the computer executable instructions 151 to match given recognized features or characteristics of the fingertips with respective predetermined computer commands and/or input data.

That is, the controller 150 can be configured to first recognize a given feature or characteristic of one or more fingertips FT in proximity with the display panel 110, and then match that recognized feature or characteristic with a predetermined associated computer command. This can be accomplished, for example, by causing the optical receiver 130 to first capture an image corresponding to one or more objects, such as fingertips FT, that are in proximity with the display panel 110. Specific examples of interpretation of such computer commands are discussed further below.

Thus, in accordance with at least one embodiment of the present disclosure, an apparatus or system 100 or the like can be configured to capture an image corresponding to an object, such as a fingertip FT, in proximity with the display panel 110, and to interpret the image as a computer command. The captured image can be indicative of one or more features and/or characteristics of the object in proximity with the display panel 110.

The controller 150 can be configured to initiate specific events in response to interpreting a given feature or characteristic of one or more fingertips FT as a specific type of computer command. For example, the controller 150 and/or computer executable instructions 151 can generate image updates in response to computer commands that are interpreted from various features or characteristics of the one or more fingertips FT in proximity with the display panel 110.

The image updates can be transmitted to the imager 120 to result in corresponding alteration, or changes to, the viewable image generated and/or projected by the imager 120. That is, the controller 150 and/or the computer executable instructions 151 can be configured to cause the imager 120 to alter and/or change the viewable image generated by the imager in response to computer commands interpreted by the controller 150 and/or the computer executable steps 151, wherein the computer commands are indicative of features or characteristics of the one or more fingertips FT that are in proximity with the display panel 110.

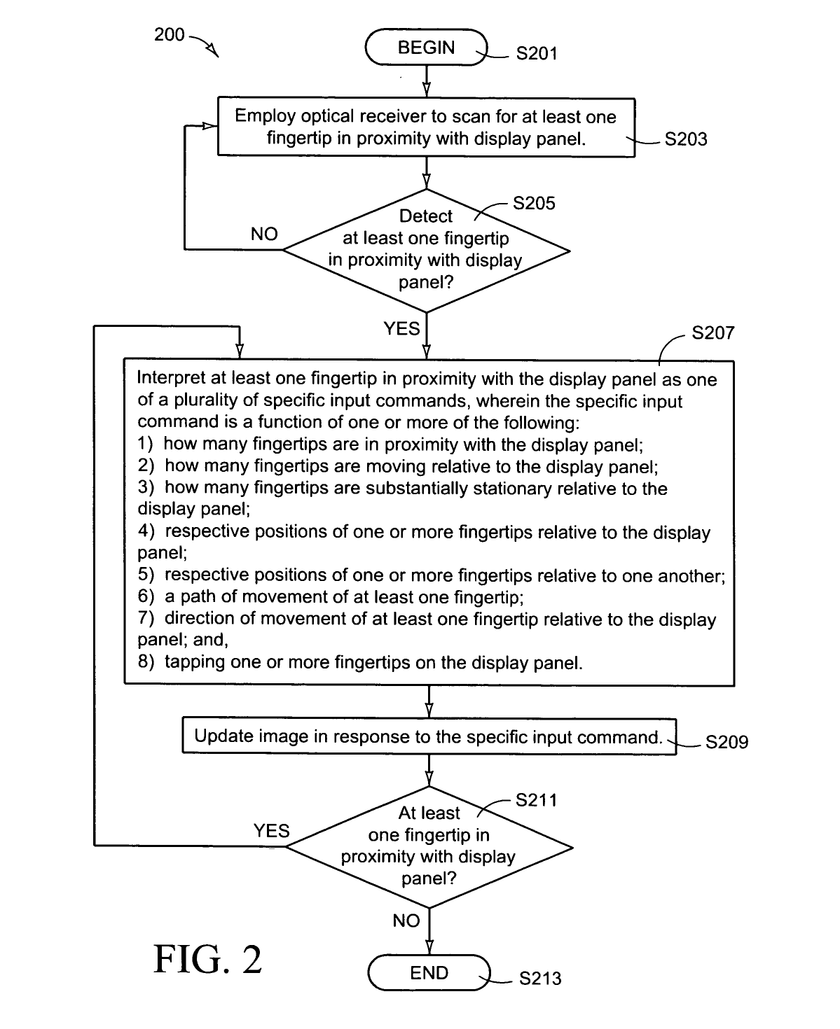

With continued reference to the drawings, FIG. 2 depicts a flow diagram 200 in accordance with at least one embodiment of the present disclosure. The flow diagram 200 begins at S201, and describes the basic steps of updating and/or altering a viewable image in response to computer commands or signals that are indicative of one or more fingertips in contact with a display panel. It is to be recognized that the term “update,” when used to describe a process in conjunction with an image may or may not indicate that the image is perceptibly changed. That is, the process of “updating an image” in accordance with one or more embodiments of the present disclosure can include either changing the image or not changing the image, depending upon the respective computer command from which the image update results.

The flow diagram 200 next proceeds to step S203 in accordance with which an optical receiver is employed to scan, or “look,” for at least one fingertip in proximity with a display panel. That is, in accordance with step S203, an optical receiver is configured to search for computer commands or signals substantially in the form of fingertips in proximity with a display panel, wherein a viewable image can also be displayed on the display panel.

From step S203, the flow diagram 200 moves to step S205, which is a query. The query of step S205 asks if at least one fingertip in proximity with the display panel has been detected. If the answer to the query of step S205 is “no,” then the flow diagram 200 returns to step S203, in accordance with which the optical receiver continues to “look for” computer signals substantially in the form of fingertips in proximity with the display panel.

However, if the answer to the query of step S205 is “yes,” then the flow diagram 200 proceeds to step S207. In step S207, the one or more fingertips in proximity with the display panel are interpreted as one of a plurality of specific computer commands, wherein the specific computer command is indicative of the one or more fingertips in proximity with the display panel. That is, the specific computer command is dependent upon at least one feature or characteristic of the one or more fingertips in proximity with the display panel.

As discussed above, a “feature” or a “characteristic” of the one or more fingertips FT in proximity with the display panel 110 can be any of a number of distinguishable traits such as recognizable positions and or manners of movement of the fingertips relative to the display panel and/or relative to one another. That is, a specific computer command can be interpreted as a function of the manner in which one or more fingertips FT in proximity with, the display panel 110 are positioned and/or moved relative to one another and/or relative to the display panel.

Examples of distinguishable traits, features, or characteristics of one or more fingertips FT in proximity with a display panel 110 include, but are not limited to, how many fingertips are in proximity with the display panel, how many fingertips are moving relative to the display panel, how many fingertips are substantially stationary relative to the display panel, respective positions of one or more fingertips relative to the display panel, respective positions of one or more fingertips relative to one another; a path of movement of at least one fingertip, a direction of movement of at least one fingertip relative to the display panel, and whether one or more fingertips are being tapped against the display panel, including how many times a fingertip is tapped.

Once the specific computer command has been determined in accordance with step S207, the flow diagram 200 progresses to step S209. In accordance with step S209, the viewable image can be updated in response to, or as a function of, the specific computer command. That is, the viewable image S209 can be altered and/or changed as a function of the computer command, which in turn is indicative of one or more fingertips in contact with the display panel. Again, as is explained above, the term, “update” can include, but is not limited to, either physically changing the image; continuing to display the same image, or redisplaying a substantially identical image, depending upon the specific respective computer command from which the update process results.

From step S209, the flow diagram 200 proceeds to step S211, which is another query. The query of step S211 asks whether there is still at least one fingertip in proximity with the display panel. If the answer to the query of step S211 is “yes,” then the flow diagram 200 returns to step S207, in which an additional computer command is interpreted based on the one or more fingertips still in proximity with the display panel. However, if the answer to the query of step S211 is “no,” then the flow diagram 200 ends at S213.

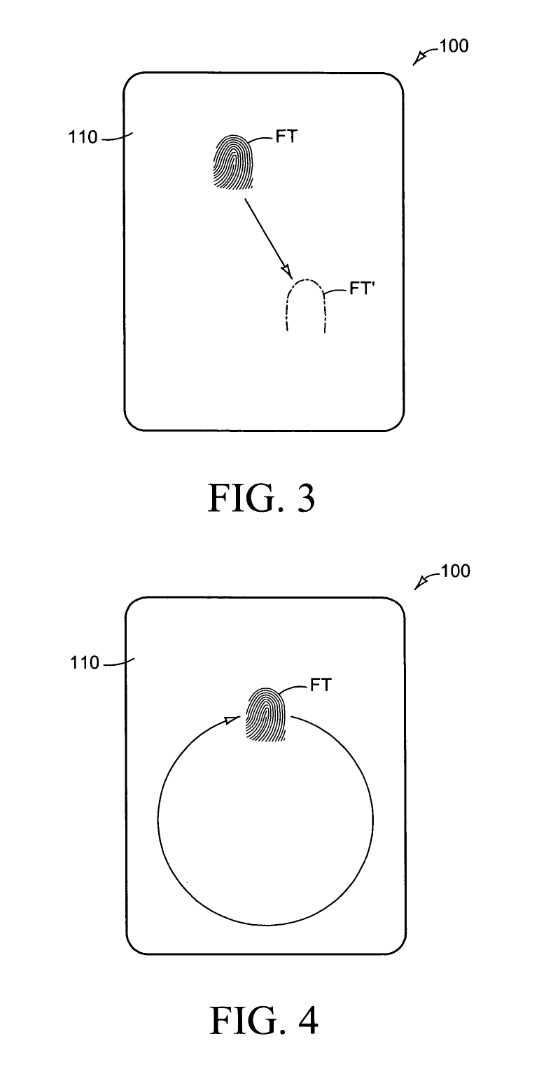

With still further reference to the drawings, FIGS. 3-7 each depict the display panel 110 of the apparatus 100 shown in FIG. 1 and discussed above, wherein the display panel is viewed from the second side 112. Each of the FIGS. 3-7 can be an example of what can be “seen” or captured by the optical receiver 130 (shown in FIG. 1 and discussed above). That is, each of the FIGS. 3-7 depicts a respective example of a distinctive feature or characteristic that can be recognized by the controller 150 (shown in FIG. 1) as at least a portion of an associated computer command.

It is understood that the examples depicted by FIGS. 3-7 are merely a few illustrative examples of features or characteristics of fingertips FT that can be recognized as at least a portion of a computer command. That is, the examples depicted in FIGS. 3-7 are not intended to be limiting, but are provided as illustrative of numerous examples of features or characteristics of fingertips FT that can be recognized as at least a portion of a computer command in accordance with one or more embodiments of the present disclosure.

With specific reference to FIG. 3, a front view of the display panel 110 of the apparatus 100 in accordance with at least one embodiment of the present disclosure is shown. The view depicted in FIG. 3 can be an example of what is “seen” or captured by the optical receiver 130 when scanning, or “looking” for, fingertips FT in proximity with the display panel. Again, it is noted that, although the following illustrative examples describe fingertips FT as being “in contact” with the display panel 110, it is understood that the methods and or apparatus in accordance with various embodiments of the present disclosure can be configured to similarly recognize fingertips in proximity with the display panel.

As is depicted in FIG. 3, a single fingertip FT can be detected as being in contact with the display panel 110. A single fingertip FT in contact with the display panel 110 can be recognized as a specific computer command. For example, a single fingertip FT in contact with the display panel 110 can be recognized such that functionality associated with a control device, such as a computer mouse (not shown), is assigned to the single fingertip FT.

The term “functionality” as used herein is defined as capable of at least partially effecting an operation of the apparatus 100. For example, in accordance with one embodiment of the present disclosure, if a given fingertip FT is assigned a functionality associated with a given control device, then the given fingertip is capable of at least partially effecting an operation of the apparatus 100 in the manner generally associated with the given control device. More specifically, for example, if a given fingertip FT is assigned functionality associated with a computer mouse, then the given fingertip can be employed to perform operations on the apparatus 100, wherein those operations are typically associated with a computer mouse.

In accordance with another embodiment of the present disclosure, one or more fingertips FT and/or other objects (not shown) can be assigned functionality, wherein various positions and/or shapes and/or movements of the fingertips and/or objects can be interpreted by the apparatus 100 as at least portions of commands such as control and/or computer commands. For example, various fingertips FT can be moved and/or positioned so as to be recognized by the apparatus 100 as in the manner of a given form of sign language or the like.

In accordance with an exemplary embodiment of the present disclosure, movement of a single fingertip FT relative to the display panel 110 can be a recognizable feature or characteristic of the fingertip. The manner in which the fingertip FT is moving (or not moving) can be yet a further recognizable feature or characteristic of the fingertip. For example, a single fingertip FT in contact with the display panel 110, wherein the single fingertip is substantially stationary, or motionless, relative to the display panel 110, can be recognized as a first specific computer command, or a first portion of a computer command. Movement of the single fingertip FT relative to the display panel 110 can be recognized as a second specific computer command, or a second portion of a computer command. That is, a single fingertip FT in substantially stationary contact with the display panel 110 can have one meaning, while a single fingertip moving across the display panel can have a different meaning.

The direction of movement of the single fingertip FT in contact with the display panel 110 can be recognized as having still further, or different, meaning. For example, the fingertip FT moved in a substantially straight line to a position indicated by FT′ can be recognized as having a given associated meaning. More specifically, a fingertip FT that moves diagonally relative to the edges of the display panel 110 can be recognized as having a specific associated meaning, whereas a fingertip that is moved substantially parallel to the edges of the display panel can be recognized as having yet another specific associated meaning.

As yet a further example, a single fingertip FT moved from an initial contact point on the display panel 110 to a second position FT′ can be recognized as a mouse movement computer command. That is, such a feature, a characteristic, or movement, of the fingertip FT can be interpreted as a command to move a cursor (not shown) from a first position on the display panel 110 to a second position on the display panel, wherein the cursor can be displayed as at least a portion of the image generated by the imager 120 (shown in FIG. 1) and displayed on the display panel.

As another specific example, a single fingertip FT can be moved relative to the display panel 110 by being tapped on the display panel 110. A fingertip FT that is tapped on the display panel 110 can be recognized as a mouse click, for example. That is, tapping a single fingertip FT on the display panel 110 can be recognized as a computer command corresponding to clicking, or depressing, a mouse button. More specifically, a single fingertip FT tapped on the display panel 110 can be recognized as a left mouse button click command. Moreover, the number of times a fingertip FT is tapped on the display panel can have a specific associated meaning.

Moving to FIG. 4, another front view of the display panel 110 of the apparatus 100 in accordance with at least one embodiment of the present disclosure is shown. In FIG. 4, yet another example of a movement of a single fingertip FT in contact with the display panel 110 is shown. Specifically, at least one fingertip FT in contact with the display panel 110 can be moved along a path that has a specific shape that can be recognized as a specific associated computer command or the like.

For example, as depicted, a single fingertip FT in contact with the display panel 110 can be moved along a path of movement that is substantially in the shape of a circle. The fingertip FT can also be recognized as moving in a given direction relative to the shape of the path of movement. For example, as depicted the fingertip FT can be recognized as moving in the general shape of a circle, as well as in a counter-clockwise direction. Thus, the shape of the path of movement of the fingertip FT, as well as the direction of movement along the path can each be interpreted as having respective associated meanings.

Numerous paths of movement of a fingertip FT in contact with the display panel 110 are possible in accordance with at least one embodiment of the present disclosure. For instance, other examples of recognizable paths of movement can include, but are not limited to a “Z” pattern, an “S” pattern, an “X” pattern, a figure “8” pattern, a square pattern, a triangular pattern, and the like.

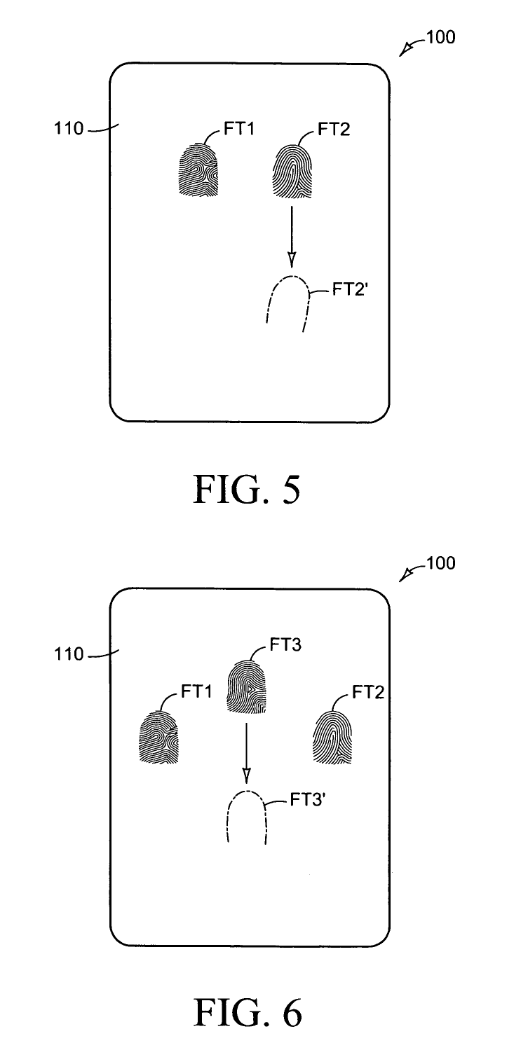

Moving now to FIG. 5, yet another front view of the display panel 110 of the apparatus 100 in accordance with at least one embodiment of the present disclosure is shown. As is depicted in FIG. 5, two or more fingertips FT can be recognized as being in contact with the display panel 110. Moreover, one or more of the fingertips FT in contact with the display panel 110 can be recognized as moving relative to the display panel, while others of the fingertips can be recognized as being substantially stationary relative to the display panel.

More specifically, as depicted in FIG. 5, a first fingertip FT1 can be recognized as being in substantially stationary contact with the display panel 110, while contemporaneously, a second fingertip FT2 can be recognized as moving relative to the display panel from an initial position to a secondary position indicated by FT2′. A first fingertip FT1 substantially stationary relative to the display panel 110 while a second fingertip FT2 is moved relative to the display panel can be interpreted as a specific associated computer command, or portion of a computer command, or the like.

The second fingertip FT2 can be moved in any of a number of possible manners, including, but not limited to, movement in a substantially straight line as is depicted in FIG. 5. Another manner in which the second fingertip FT2 can be moved, is that of tapping the second fingertip on the display panel 110 while the first fingertip FT1 is substantially stationary relative to the display panel.

Such tapping movement of the second fingertip FT2 can be interpreted to have a specific associated meaning. For example, a first fingertip FT1 that is substantially stationary relative to the display panel 110 while a second fingertip FT2 is tapped on the display panel can be interpreted as a right mouse button click command.

Moving to FIG. 6, yet another front view of the display panel 110 of the apparatus 100 in accordance with at least one embodiment of the present disclosure is shown. As is shown in FIG. 6, a first fingertip FT1 in contact with the display panel 110, and a second fingertip FT2 in contact with the display panel, can both be substantially stationary relative to the display panel while a third fingertip FT3 in contact with the display panel is moving relative to the display panel.

That is, two or more fingertips FT1, FT2 can be substantially stationary relative to the display panel 110, while at least one fingertip FT3 is contemporaneously moving relative to the display panel. As a specific example, the features or characteristics of the fingertips FT1, FT2, and FT3 depicted in FIG. 6 can be interpreted as a “scroll screen” or “scroll page” command.

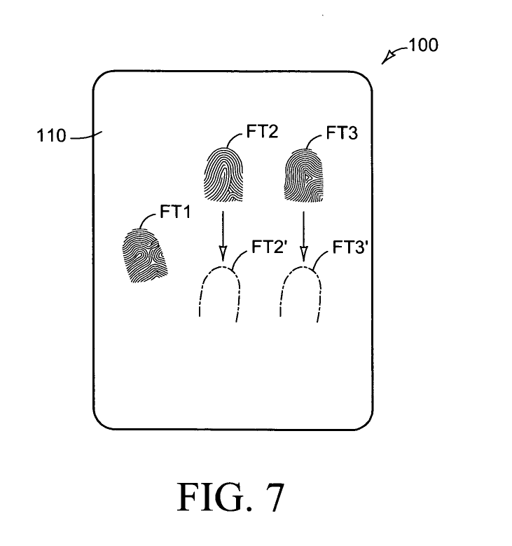

With reference now to FIG. 7, still another front view of the display panel 110 of the apparatus 100 in accordance with at least one embodiment of the present disclosure is shown. As is depicted in FIG. 7, a first fingertip FT1 in contact with the display panel 110 can be substantially stationary while a second fingertip FT2 in contact with the display panel, and a third fingertip FT3 in contact with the display panel, can both be moved relative to the display panel from respective initial positions to respective secondary positions FT2′ and FT3′.

That is, as depicted in FIG. 7, one or more fingertips FT1 can be substantially stationary relative to the display panel 110 while two or more fingertips FT2, FT3 are contemporaneously moved relative to the display panel. The movement of the second fingertip FT2 and the third fingertip FT3 can take any of a number of possible forms. For example, the second fingertip FT2 and the third fingertip FT3 can be moved in a substantially circumscriptive manner relative to the first fingertip FT1.

In other words, the second fingertip FT2 and the third fingertip FT3 can be moved about the first fingertip FT1, which can be substantially used as a pivot point. Such movement of one or more fingertips FT1, FT2, FT3 can be recognized as one of a number of possible computer commands or the like. For example, such movement of the fingertips FT1, FT2, FT3, as described above with respect to FIG. 7, can be interpreted as a “rotate object” command.

As yet another example of interpreting various features or characteristics of one or more fingertips FT in proximity with the display panel 110, a given number of fingertips in proximity with the display panel 110 can be interpreted as a command to activate an associated color of “paintbrush” for adding color to areas of a viewable image. More specifically, detecting a single fingertip FT in proximity with the display panel 110 can be interpreted as a computer command to activate a first color paintbrush.

Similarly, detecting two fingertips FT in proximity with the display panel 110 can be interpreted as a computer command to activate a second color paintbrush. Likewise, recognizing three fingertips FT in proximity with the display panel 110 can be interpreted as a computer command to activate a third color paintbrush, and so on in a like manner with regard to detecting four fingertips, or five fingertips, in proximity with the display panel.

In accordance with at least one embodiment of the present disclosure, the computer executable instructions 151 can be configured to receive information from the optical receiver 130. The information can be indicative of at least one object such as a fingertip FT or the like which is detected to be in proximity with the display surface SS.

The computer executable instructions 151 can be further configured to use the information to recognize at least one characteristic and/or feature of the objects FT and to interpret the characteristic and/or feature as an associated computer command. The specific characteristics and/or features on which the computer command is based can include, but are not limited to, how many objects FT are detected to be in proximity with the display surface SS, and which of the detected objects are moving and which are substantially stationary.

Other characteristics and/or features on which the computer command can be based include an object FT tapping on the display surface SS. An object FT tapping on the display surface SS can be interpreted as a computer mouse “click.” Another example of a characteristic and/or feature is a substantially stationary first object FT and a second object tapping on the display surface SS. This can be interpreted as a right mouse “click.”

Yet another characteristic and/or feature on which the computer command can be based is a substantially stationary first object FT and a second object moving substantially across the display surface. This can be interpreted by the computer executable instructions 151 as a “scroll page” command. Still another characteristic and/or feature on which the computer command can be based is a substantially stationary first object FT and a substantially stationary second object, and a third object moving substantially across the display surface SS. This can also be interpreted as a “scroll page” command.

The computer command can be based on a substantially stationary first object FT, and a second object moving substantially across the display surface SS and a third object moving substantially across the display surface. This can be interpreted by the computer executable instructions 151 as a “rotate object” command. In accordance with yet another embodiment of the present invention, the computer command can be a command to activate a predetermined paintbrush color, wherein the color is associated with how many objects FT are detected to be in proximity with the display surface SS.

As yet a further example, the computer command can be based on respective locations of each of the objects FT relative to the display panel SS. The computer command can be based on a direction of movement of at least one object FT relative to another object. The computer command can be based on a given distance between one object FT and another object. Moreover, the computer command can be based on a velocity of one object FT relative to another object and/or relative to the display surface SS.

The computer executable instructions 151 can be further configured to cause an operation to be performed in response to the computer command. The operation can be any operation of which the apparatus 100 is capable of performing. For example, the operation can be, but is not limited to, updating the image which is displayed on the display surface SS. In accordance with another embodiment of the present disclosure, a display system such as the apparatus 100 can include the computer executable instructions 151 which are substantially configured to perform as is described immediately above.

In accordance with at least one embodiment of the present disclosure, a method includes detecting at least one object in proximity with a display panel and recognizing at least one feature or characteristic of at least one of the objects. An image can be updated using the recognized feature or characteristic. For example, the method can include interpreting at least one feature or characteristic of one or more objects in proximity with a display panel as a specific computer command. The method can include providing a display panel such as the display panel 110, which is described above with respect to FIG. 1 and FIGS. 3-7. A display surface can be defined on the display panel. An image can be displayed on the display surface. The image can be displayed by projecting the image onto one side of the display panel so as to be viewable from the opposite side.

The method can include optically detecting proximity and/or contact of at least one fingertip with the display panel. A signal can be generated in response to optically detecting proximity of at least one fingertip with the display panel. The signal can be indicative of the fingertip, or fingertips, that are in proximity with the display panel. That is, the signal can be indicative of at least one feature or characteristic of the fingertip, or fingertips.

A digital processing device, such as a controller 150, can be included in accordance with the method. The method can include processing the signal within the digital processing device. Processing the signal can include interpreting the signal as a computer command.

Processing the signal can include capturing an image of one or more objects such as fingertips, and can further include recognizing a given feature or characteristic of one or more fingertips in proximity with the display panel and interpreting the given feature or characteristic as a specific computer command associated with the given feature or characteristic. The displayed image can be updated, or adjusted, in response to the signal, or as a function of at least one feature or characteristic of one or more fingertips or objects in proximity with the display panel. In accordance with at least one embodiment of the present disclosure, displaying the image on the display panel can include displaying a cursor on the display surface. Updating the image can include causing the cursor to move relative to the display surface.

An optical receiver can be provided and can be directed at the display panel. The optical receiver can be employed to optically scan the display panel in order to detect one or more fingertips in proximity with the display panel. The one or more fingertips in proximity with the display panel can be detected by receiving light into the optical receiver, wherein the light is reflected from the one or more fingertips in proximity with the display panel. A signal can be generated by the optical receiver, wherein the signal is indicative of the one or more fingertips in proximity with the display panel.

A controller, or control electronics, can be provided and can be caused to receive the signal from the optical receiver. The controller can process the signal in any of a number of various manners. For example, the controller can process the signal by analyzing the signal. As a result of analyzing the signal, the controller can recognize at least one feature or characteristic of the one or more fingertips in proximity with the display panel.

Processing and/or analyzing the signal can include recognizing at least one feature or characteristic of the one or more fingertips in proximity with the display surface and/or the display panel. Processing and/or analyzing can also include interpreting the at least one recognized feature or characteristic as an associated computer command.

Such recognizable features or characteristics can include, but are not limited to, how many fingertips are in proximity and/or contact with the display panel and/or display surface, how many fingertips are moving and/or substantially stationary relative to the display surface and/or display panel, respective positions of the one or more fingertips relative to the display panel and/or display surface, respective positions of the one or more fingertips relative to one another, shape of and/or direction of movement along, a path of movement of one or more of the fingertips, and whether one or more fingertips are tapped on the display surface and/or display panel, as well as how many taps occur.

In accordance with at least one embodiment of the present disclosure a method can include displaying an image on a display surface. The method can include recognizing an object tapping on the display surface and interpreting the object tapping on the display surface as an associated computer command. As is explained above, the object can be, but is not limited to, a fingertip FT, for example. The computer command can be, but is not limited to, a mouse “click.”

In accordance with at least one embodiment of the present disclosure a method can include recognizing one or more characteristics and/or features of a plurality of objects detected to be in proximity with a display surface. The method can include interpreting the one or more characteristics and/or features as an associated computer command. The computer command can be based on how many objects are detected and which of the detected objects are moving and which are substantially stationary.

The method can include displaying an image on the display surface. The method can include performing an operation in response to interpreting the one or more characteristics and/or features as a computer command. The method can include interpreting a substantially stationary first object and a second object tapping on the display surface as a predetermined computer command. The predetermined computer command can be a right “click” of a computer mouse.

The method can include interpreting a substantially stationary first object and a second object moving substantially across the display surface as a predetermined computer command. This command can be, for example, a “scroll-page” command. The method can include interpreting a substantially stationary first object and a substantially stationary second object and a third object moving substantially across the display surface as a predetermined computer command. This command can be, for example, a scroll-page command.

The method can include interpreting a substantially stationary first object and a second object moving substantially across the display surface and a third object moving substantially across the display surface as a predetermined computer command. This computer command can be, for example, a “rotate-object” command.

In accordance with at least one embodiment of the present disclosure a method can include detecting a plurality of objects in proximity with a display surface and assigning one or more objects functionality associated with a control device. The control device can be, but is not limited to, a computer mouse, a joystick, and a keypad. The functionality can be based on how many objects are detected and which of the detected objects are moving and which are substantially stationary. The method can include displaying an image on the display surface, and the functionality can include updating the image.

In accordance with at least one embodiment of the present disclosure, a method can include capturing an image corresponding to an object tapping on a display surface. The method can further include interpreting the image as a computer command. The object can be a fingertip, for example. The computer command can be a mouse click, for example. The method can include displaying a second image on the display surface. That is, the image that is “captured” can be different in some manner than the image that is displayed on the display surface.

In accordance with at least one embodiment of the present invention, a method can include detecting a plurality of objects in proximity with a display surface and assigning the one or more objects functionality associated with a control device, wherein the functionality is based on how many objects are detected and which of the detected objects are moving and which of the detected objects are substantially stationary. The method can further include displaying an image on the display surface and the functionality can include, for example, updating the image.

The control device can be any control device that is configured to generate control signals and/or a control command such as an input command or the like. The control device can be, for example, a computer mouse, a joystick, or a keypad. Furthermore, each of the plurality of objects can be a respective fingertip.

The preceding description has been presented only to illustrate and describe methods and apparatus in accordance with respective embodiments of the present disclosure. It is not intended to be exhaustive or to limit the disclosure to any precise form disclosed. Many modifications and variations are possible in light of the-above teaching. It is intended that the scope of the subject matter of the claims be defined by the following claims.

What is claimed is:

1. A method, comprising:
capturing an image corresponding to an object tapping on a display surface; and
interpreting the image as a computer command.

2. The method of claim 1, wherein the computer command is a computer input command.

3. The method of claim 1, wherein the object is a fingertip.

4. The method of claim 1, wherein the computer command is a mouse click.

5. The method of claim 1, further comprising displaying a second image on the display surface.

6. A method, comprising:
recognizing one or more characteristics of a plurality of objects detected to be in proximity with a display surface; and
interpreting the one or more characteristics as an associated computer command, wherein the computer command is based on:
how many objects are detected; and
which of the detected objects are moving and which of the detected objects are substantially stationary.

7. The method of claim 6, further comprising displaying an image on the display surface.

8. The method of claim 6, further comprising performing an operation in response to interpreting the one or more characteristics as a computer command.

9. The method of claim 6, wherein a substantially stationary first object and a second object tapping on the display surface is interpreted as a predetermined computer command.

10. The method of claim 9, wherein the predetermined computer command is a right mouse click.

11. The method of claim 6, wherein a substantially stationary first object and a second object moving substantially across the display surface is interpreted as a predetermined computer command.

12. The method of claim 11, wherein the predetermined computer command is a scroll-page command.

13. The method of claim 6, wherein a substantially stationary first object, and a substantially stationary second object, and a third object moving substantially across the display surface is interpreted as a predetermined computer command.

14. The method of claim 13, wherein the predetermined computer command is a scroll-page command.

15. The method of claim 6, wherein a substantially stationary first object, and a second object moving substantially across the display surface, and a third object moving substantially across the display surface is interpreted as a predetermined computer command.

16. The method of claim 15, wherein the predetermined computer command is a rotate-object command.

17. The method of claim 6, wherein:
the one or more characteristics includes a given number of the objects in proximity with the display surface; and
the associated computer command includes activation of a predetermined paintbrush color, wherein the color is associated with how many of the objects are detected.

18. A method, comprising:
detecting a plurality of objects in proximity with a display surface; and
assigning the one or more objects functionality associated with a control device, wherein the functionality is based on:
how many objects are detected; and
which of the detected objects are moving and which of the detected objects are substantially stationary.

19. The method of claim 18, further comprising displaying an image on the display surface.

20. The method of claim 19, wherein the functionality comprises updating the image.

21. The method of claim 18, wherein the control device is selected from the group comprising, a computer mouse, a joystick, and a keypad.

22. The method of claim 18, wherein each of the objects is a respective fingertip.

23. An apparatus comprising a computer readable medium including computer executable instructions configured to cause control electronics to:
receive information for an image captured by an optical receiver, wherein the information corresponds to an object tapping on a display surface; and
interpret the information as a computer command.

24. The apparatus of claim 23, wherein each of the objects is a respective fingertip.

25. The apparatus of claim 23, wherein the computer command is a mouse click.

26. The apparatus of claim 23, wherein the computer executable instructions are further configured to cause an imager to project an image onto the display surface.

27. An apparatus comprising a computer readable medium including computer executable instructions configured to cause control electronics to:
receive information from an optical receiver, wherein the information is indicative of a plurality of objects detected to be in proximity with a display surface;
use the information to recognize one or more characteristics of the objects; and
interpret the one or more characteristics as an associated computer command, wherein the computer command is based on:
how many objects are detected; and
which of the detected objects are moving and which of the detected objects are substantially stationary.

28. The apparatus of claim 27, wherein the computer executable instructions are further configured to cause an imager to project an image onto the display surface.

29. The apparatus of claim 27, wherein each of the objects is a respective fingertip.

30. The apparatus of claim 27, wherein the computer executable instructions are further configured to cause an operation to be performed in response to the computer command.

31. The apparatus of claim 27, wherein an object tapping on the display surface is interpreted as a predetermined computer command.

32. The apparatus of claim 31, wherein the predetermined computer command is a mouse click.

33. The apparatus of claim 27, wherein a substantially stationary first object and a second object tapping on the display surface is interpreted as a predetermined computer command.

34. The apparatus of claim 33, wherein the predetermined computer command is a right mouse click.

35. The apparatus of claim 27, wherein a substantially stationary first object and a second object moving substantially across the display surface is interpreted as a predetermined computer command.

36. The apparatus of claim 35, wherein the predetermined computer command is a scroll-page command.

37. The apparatus of claim 27, wherein a substantially stationary first object, and a substantially stationary second object, and a third object moving substantially across the display surface is interpreted as a predetermined computer command.

38. The apparatus of claim 37, wherein the predetermined computer command is a scroll-page command.

39. The apparatus of claim 27, wherein a substantially stationary first object, and a second object moving substantially across the display surface, and a third object moving substantially across the display surface is interpreted as a predetermined computer command.

40. The apparatus of claim 39, wherein the predetermined computer command is a rotate-object command.

41. The apparatus of claim 27, wherein a given number of objects in proximity with the display surface is interpreted as a computer command to activate a predetermined paintbrush color, wherein the color is associated with how many objects are detected.

42. A display system, comprising:
a display panel;
a first component configured to project an image at the display panel;
a second component configured to optically scan the display panel and to generate a signal using the optical scan; and
a controller configured to receive the signal and use the signal to recognize one or more characteristics of a plurality of objects detected to be in proximity with the display panel and interpret the one or more characteristics as an associated computer command, wherein the one or more characteristics includes:
how many objects are detected; and
which of the detected objects are moving and which of the detected objects are substantially stationary.

43. The system of claim 42, wherein the controller is further configured to perform an operation in response to the computer command.

44. The system of claim 43, wherein the operation is updating the image.

45. The system of claim 42, wherein the one or more characteristics further includes respective locations of each of the objects relative to the display panel.

46. The system of claim 42, wherein the one or more characteristics further includes direction of movement of at least one object relative to another object.

47. The system of claim 42, wherein the one or more characteristics further includes a given distance between one of the objects and another of the objects.

48. The system of claim 42, wherein the one or more characteristics further includes a velocity of at least one object relative to another object.

49. The system of claim 42, wherein the one or more characteristics further includes a velocity of at least one object relative to the display panel.

50. An apparatus, comprising:
a display panel;
means for projecting an image at a first side of the display panel to be viewable from a second side of the display panel;
means for recognizing one or more characteristics of a plurality of objects detected to be in proximity with the second side of the display panel; and
means for interpreting one or more characteristics of the objects as an associated computer command, wherein the one or more characteristics includes:
how many objects are detected; and
which of the detected objects are moving and which of the detected objects are substantially stationary.

51. The apparatus of claim 50, wherein the one or more characteristics further includes respective locations of each of the objects relative to the display panel.

52. The apparatus of claim 50, wherein the one or more characteristics further includes direction of movement of at least one object relative to another object.

53. The apparatus of claim 50, wherein the one or more characteristics further includes a given distance between one of the objects and another of the objects.

54. The apparatus of claim 50, wherein the one or more characteristics further includes a velocity of at least one object relative to another object.

55. The apparatus of claim 50, wherein the one or more characteristics further includes a velocity of at least one object relative to the display panel.

56. The apparatus of claim 50, further comprising means for performing an operation in response to the computer command.

57. The apparatus of claim 56, wherein the operation is updating the image.

58. An apparatus, comprising:
a display surface configured to display a viewable image;
an optical receiver configured to receive light reflected from a plurality of fingertips in proximity with the display surface, and to generate a signal indicative of the fingertips; and
a controller configured to:
receive the signal and use the signal to recognize at least one characteristic of the fingertips in response to receiving the signal; and
interpret the one or more characteristics as an associated computer command, wherein the one or more characteristics includes:
how many fingertips are detected; and
which of the detected fingertips are moving and which of the detected fingertips are substantially stationary.

59. The apparatus of claim 58, wherein the one or more characteristics includes respective locations of each of the fingertips relative to the display panel.

60. The apparatus of claim 58, wherein the one or more characteristics includes direction of movement of at least one of the fingertips relative to another fingertip.

61. The apparatus of claim 58, wherein the one or more characteristics includes a given distance between one of the fingertips and another of the fingertips.

62. The apparatus of claim 58, wherein the one or more characteristics includes a velocity of at least one fingertip relative to another fingertip.

63. The apparatus of claim 58, wherein the one or more characteristics includes a velocity of at least one fingertip relative to the display panel.

64. The apparatus of claim 58, wherein the controller is further configured to perform an operation in response to the computer command.

65. The apparatus of claim 64, wherein the operation is updating the image.
